(19) United States
(12) Patent Application Publication
(10) Pub. No.: US 2026/0145744 A1
(43) Pub. Date: May 28, 2026

(54) BODY OF VEHICLE

(71) Applicants: TOYOTA JIDOSHA KABUSHIKI KAISHA, Toyota-shi (JP); SUBARU CORPORATION, Tokyo (JP)

(72) Inventors: Hiroyuki KURATA, Toyota-shi (JP); Hikaru MIURA, Shibuya-ku (JP)

(73) Assignees: TOYOTA JIDOSHA KABUSHIKI KAISHA, Toyota-shi (JP); SUBARU CORPORATION, Tokyo (JP)

(21) Appl. No.: 19/364,035

(22) Filed: Oct. 21, 2025

(30) Foreign Application Priority Data
Nov. 22, 2024 (JP) 2024-204229

(51) Int. Cl. B62D 25/04; B62D 21/15; B62D 29/00

(52) U.S. Cl. CPC B62D 25/04; B62D 21/152; B62D 29/00

(57) ABSTRACT

A body of a vehicle includes a front pillar extending in an up-down direction in front of a cabin, and an upper member extending forward from a middle position of the front pillar. A rear end portion of the upper member that is connected to the front pillar includes a first panel that constitutes an upper part of the upper member, and a second panel that faces the first panel and constitutes a lower part of the upper member. A material of the first panel has a higher tensile strength than a material of the second panel. The second panel is expanded downward such that a sectional shape of the upper member expands toward the front pillar.

### CROSS-REFERENCE TO RELATED APPLICATION

This application claims priority to Japanese Patent Application No. 2024-204229 filed on Nov. 22, 2024. The disclosure of the above-identified application, including the specification, drawings, and claims, is incorporated by reference herein in its entirety.

### BACKGROUND

### 1. Technical Field

The technology disclosed in the present specification relates to a body of a vehicle.

### 2. Description of Related Art

Japanese Unexamined Patent Application Publication No. 2022-30065 (JP 2022-30065 A) discloses a body of a vehicle. The body includes a front pillar extending in an up-down direction in front of a cabin, and an upper member (also referred to as “fender apron upper member”) extending forward from a middle position of the front pillar. An energy absorbing portion is provided in part of the middle position of the front pillar. The energy absorbing portion is configured to induce a predetermined plastic deformation in the front pillar when a rearward collision load is applied to the upper member.

### SUMMARY

Electrified vehicles such as battery electric vehicles (BEVs) are relatively heavy. When a vehicle is heavy and a small overlap frontal collision occurs, the upper member alone may be unable to sufficiently absorb collision energy, and the front pillar may be displaced toward the cabin. To avoid this, the strength of the upper member may be increased, but the tradeoff is that there may be a portion of the upper member that do not undergo plastic deformation in the event of collision (so-called uncrushed portion). In this case as well, the upper member alone may be unable to sufficiently absorb the collision energy, and the front pillar may be displaced toward the cabin.

In view of the above, the present specification provides a body structure that is excellent at absorbing collision energy particularly in a small overlap frontal collision.

A body of a vehicle disclosed in the present specification includes a front pillar extending in an up-down direction in front of a cabin, and an upper member extending forward from a middle position of the front pillar. A rear end portion of the upper member that is connected to the front pillar includes a first panel that constitutes an upper part of the upper member, and a second panel that faces the first panel and constitutes a lower part of the upper member. A material of the first panel has a higher tensile strength than a material of the second panel. The second panel is expanded downward such that a sectional shape of the upper member expands toward the front pillar.

In the above body, the first panel constituting the upper part of the upper member and the second panel constituting the lower part of the upper member are made of materials with different tensile strengths. The first panel constituting the upper part is made of a material with a relatively high tensile strength, and increases a load acting on the upper member in the event of collision. Therefore, the amount of collision energy absorbed by plastic deformation of the upper member increases. The second panel constituting the lower part is made of a material with a relatively low tensile strength, and promotes the plastic deformation of the upper member. This reduces an uncrushed portion generated in the upper member. The second panel is configured to expand the sectional shape of the upper member, and serves to stabilize the deformation mode of the upper member. As above, the collision energy can effectively be absorbed by the upper member particularly in a small overlap frontal collision.

In an embodiment of the present technology, the second panel may have an uneven shape that induces plastic deformation of the second panel in response to a load from a front.

With the above configuration, it is possible to increase the possibility that the second panel will be deformed in a predetermined deformation mode in the event of collision. Therefore, the collision energy can be absorbed more effectively by the upper member.

In an embodiment of the present technology, the front pillar may include a third panel extending upward from the middle position of the front pillar, and a fourth panel extending downward from the middle position of the front pillar. A material of the third panel may have a higher tensile strength than the material of the first panel.

In the above configuration, the third panel constituting the upper part of the front pillar is made of a material with a relatively high tensile strength. The third panel receives the load transmitted from the upper member in the event of collision, and increases the load acting on the upper member. Therefore, the amount of collision energy absorbed by the plastic deformation of the upper member increases.

In the above embodiment, a material of the fourth panel may have a lower tensile strength than the material of the third panel.

In the above configuration, the fourth panel constituting the lower part of the front pillar is made of a material with a relatively low tensile strength. Therefore, when the deformed upper member interferes with the front pillar, the fourth panel undergoes plastic deformation. The deformed upper member is housed in an internal space of the front pillar, and displacement of the front pillar toward the cabin is suppressed.

In the above embodiment, a lower end portion of the third panel of the front pillar may have a shape having a lower yield strength than another portion of the third panel that is adjacent to the lower end portion.

With the above configuration, when the deformed upper member interferes with the front pillar, the lower end portion of the third panel can also undergo plastic deformation. Therefore, the displacement of the front pillar toward the cabin is further suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing a body 10 according to an embodiment;

FIG. 2 is a sectional view of a joint between a right front pillar 20R and a right upper member 30R of the body 10 according to the embodiment as viewed from the left, in which suffix “R” of each reference numeral is omitted;

FIG. 3 is a sectional view taken along line III-III shown in FIG. 2; and

FIG. 4 is a sectional view schematically showing plastic deformation of a lower end portion 22a of a third panel 22 of the front pillar 20, and an internal space 40 that houses an uncrushed portion of the deformed upper member 30.

### DETAILED DESCRIPTION OF EMBODIMENTS

A body 10 of one embodiment will be described with reference to the drawings. As described in the present embodiment, the body 10 may be used as a body of an electrified vehicle (BEV: Battery Electric Vehicle). The electrified vehicle includes a traveling motor (not shown). The electrified vehicle travels by driving wheels (not shown) using the traveling motor.

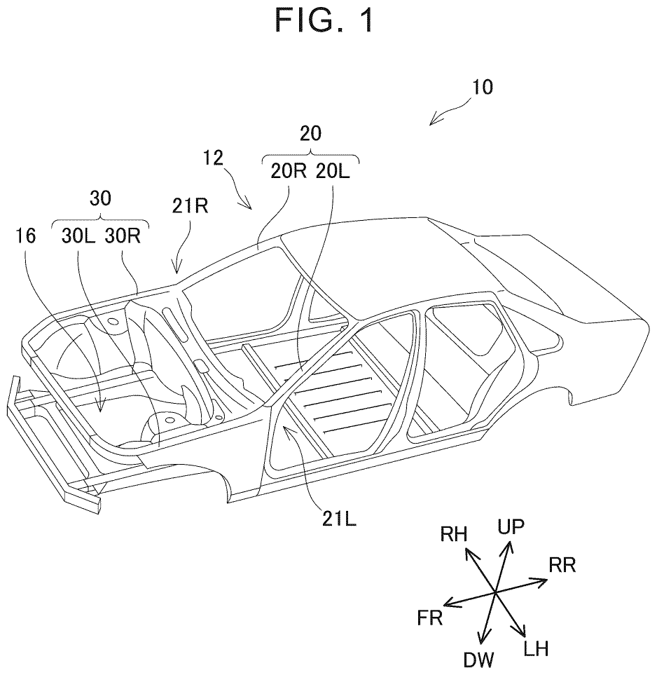

In FIGS. 1 to 4, a direction FR indicates forward in a vehicle front-rear direction, and a direction RR indicates rearward in the vehicle front-rear direction. A direction RH indicates rightward in a vehicle right-left direction, and a direction LH indicates leftward in the vehicle right-left direction. A direction UP indicates upward in a vehicle up-down direction, and a direction DW indicates downward in the vehicle up-down direction.

As shown in FIG. 1, the body 10 includes a pair of front pillars 20 and a pair of upper members 30. The front pillars 20 include a right front pillar 20R located on the right side of the body 10, and a left front pillar 20L located on the left side of the body 10. Each of the front pillars 20R, 20L extends in the up-down direction in front of a cabin 12. Each of the front pillars 20R, 20L has a generally tubular shape, and defines an internal space extending in the vehicle front-rear direction.

The upper members 30 include a right upper member 30R located on the right side of the body 10, and a left upper member 30L located on the left side of the body 10. The right upper member 30R extends forward from a middle position 21R of the right front pillar 20R. The left upper member 30L extends forward from a middle position 21L of the left front pillar 20L. Each of the upper members 30R, 30L has a generally tubular shape, and defines an internal space extending in the vehicle up-down direction.

In the present embodiment, the body 10 has a bilaterally symmetrical shape. That is, the right front pillar 20R and the left front pillar 20L have a bilaterally symmetrical shape and have the same configuration and function. The right upper member 30R and the left upper member 30L have a bilaterally symmetrical shape and have the same configuration and function. Therefore, in the following description, the front pillars 20R, 20L will be described as the front pillars 20 without distinguishing between right and left. Similarly, the upper members 30R, 30L will be described as the upper members 30 without distinguishing between right and left.

The body 10 has a compartment 16 within a range surrounded by the upper members 30. The compartment 16 is provided forward of the cabin 12. Although illustration is omitted, the compartment 16 houses an electric circuit that controls the traveling motor, etc.

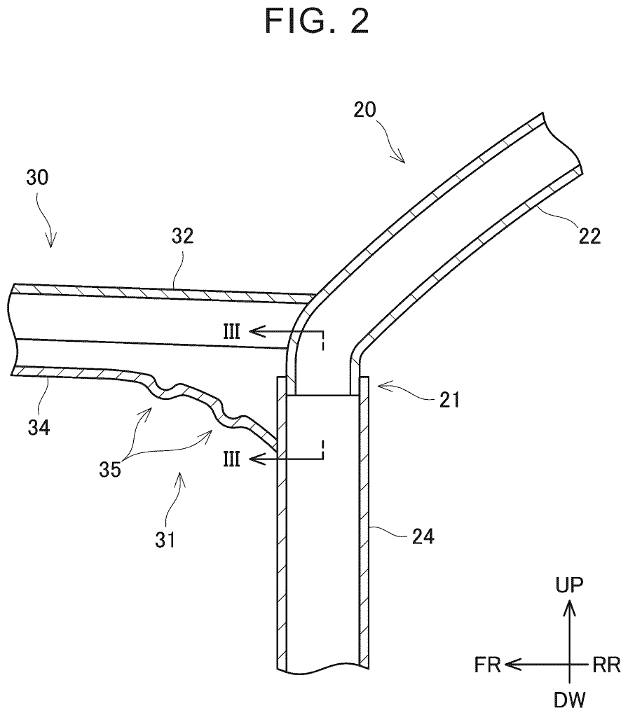

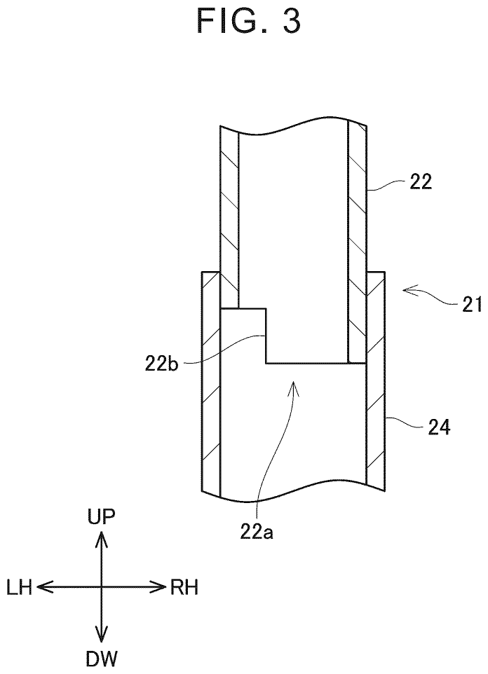

A joint between the front pillar 20 and the upper member 30 will be described with reference to FIGS. 2 and 3. FIGS. 2 and 3 show a joint between the right front pillar 20R and the right upper member 30R. The upper member 30 includes a rear end portion 31 connected to the front pillar 20. The rear end portion 31 of the upper member 30 includes a first panel 32 that constitutes the upper part of the upper member 30, and a second panel 34 that faces the first panel 32 and constitutes the lower part of the upper member 30. A space extending in the vehicle front-rear direction is defined between the first panel 32 and the second panel 34. The second panel 34 is expanded downward such that the sectional shape of the upper member 30 expands toward the front pillar 20. As an example, the first panel 32 and the second panel 34 are made of steel sheets.

The front pillar 20 includes a third panel 22 and a fourth panel 24. The third panel 22 extends upward from the middle position 21 of the front pillar 20. The fourth panel 24 extends downward from the middle position 21 of the front pillar 20. The third panel 22 and the fourth panel 24 are joined to each other at the middle position 21 of the front pillar 20. The first panel 32 of the upper member 30 is mainly joined to the third panel 22 of the front pillar 20. The second panel 34 of the upper member 30 is mainly joined to the fourth panel 24 of the front pillar 20. As an example, the third panel 22 and the fourth panel 24 are made of steel sheets. An inner panel (not shown) is joined to each of the third panel 22 and the fourth panel 24 from the inside of the body 10 (i.e., from the cabin 12 side). Each of the third panel 22 and the fourth panel 24 defines a space extending in the vehicle up-down direction with the inner panel.

In the present embodiment, it is appropriate that the material of the first panel 32 have a higher tensile strength than the material of the second panel 34. For example, the metal constituting the first panel 32 may be a steel material with a tensile strength of 400 N/mm² or more, a steel material with a tensile strength of 500 N/mm² or more, or a steel material with a tensile strength of 600 N/mm² or more. As an example, the first panel 32 of the present embodiment is made of a high tensile strength steel sheet (e.g., SPFH590) with a tensile strength of 590 N/mm². The metal constituting the second panel 34 may be a steel material with a tensile strength of 100 N/mm² or more, a steel material with a tensile strength of 200 N/mm² or more, or a steel material with a tensile strength of 300 N/mm² or more. As an example, the second panel 34 of the present embodiment is made of a steel sheet (e.g., SPHC) with a tensile strength of 270 N/mm².

It is appropriate that the material of the third panel 22 have a higher tensile strength than the material of the first panel 32. For example, the metal constituting the third panel 22 may be a steel material with a tensile strength of 700 N/mm² or more, a steel material with a tensile strength of 800 N/mm² or more, a steel material with a tensile strength of 900 N/mm² or more, or a steel material with a tensile strength of 1000 N/mm² or more. As an example, the third panel 22 of the present embodiment is made of a steel sheet (e.g., SCHA20B) with a tensile strength of approximately 1000 N/mm² or more.

It is appropriate that the material of the fourth panel 24 have a lower tensile strength than the material of the third panel 22. For example, the metal constituting the fourth panel 24 may be a steel material with a tensile strength of 400 N/mm² or more, a steel material with a tensile strength of 500 N/mm² or more, or a steel material with a tensile strength of 600 N/mm² or more. The fourth panel 24 of the present embodiment is made of a high tensile strength steel sheet (e.g., SPFH590) with a tensile strength of 590 N/mm².

As described above, in the body 10 of the present embodiment, the first panel 32 constituting the upper part of the upper member 30 and the second panel 34 constituting the lower part of the upper member 30 are made of materials with different tensile strengths. The first panel 32 constituting the upper part is made of a material with a relatively high tensile strength, and increases a load acting on the upper member 30 in the event of collision. Therefore, the amount of collision energy absorbed by plastic deformation of the upper member 30 increases. The second panel 34 constituting the lower part is made of a material with a relatively low tensile strength, and promotes the plastic deformation of the upper member 30. This reduces an uncrushed portion generated in the upper member 30. In addition, the second panel 34 is configured to expand the sectional shape of the upper member 30, and serves to stabilize the deformation mode of the upper member 30. As above, the collision energy can effectively be absorbed by the upper member 30 particularly in a small overlap frontal collision.

In the body 10 of the present embodiment, the third panel 22 constituting the upper part of the front pillar 20 is made of a material with a relatively high tensile strength. Specifically, the material of the third panel 22 has a higher tensile strength than the material of the first panel 32 of the upper member 30 connected to the third panel 22. With this configuration, the third panel 22 can receive the load transmitted from the upper member 30 in the event of collision, and increase the load acting on the upper member 30. Therefore, the amount of collision energy absorbed by the plastic deformation of the upper member 30 further increases.

As shown in FIG. 2, the second panel 34 is provided with a plurality of bead portions 35. The bead portions 35 define an uneven shape that induces plastic deformation of the second panel 34 in response to the load from the front. With this configuration, it is possible to increase the possibility that the second panel 34 will be deformed in a predetermined deformation mode in the event of collision. Therefore, the collision energy can be absorbed more effectively by the upper member 30. As an example, in the second panel 34 of the present embodiment, two beads 35 are provided on the lower surface of the second panel 34 as the bead portions 35. The two beads 35 each extend in the right-left direction. The specific shape and the number of the bead portions 35 are not particularly limited.

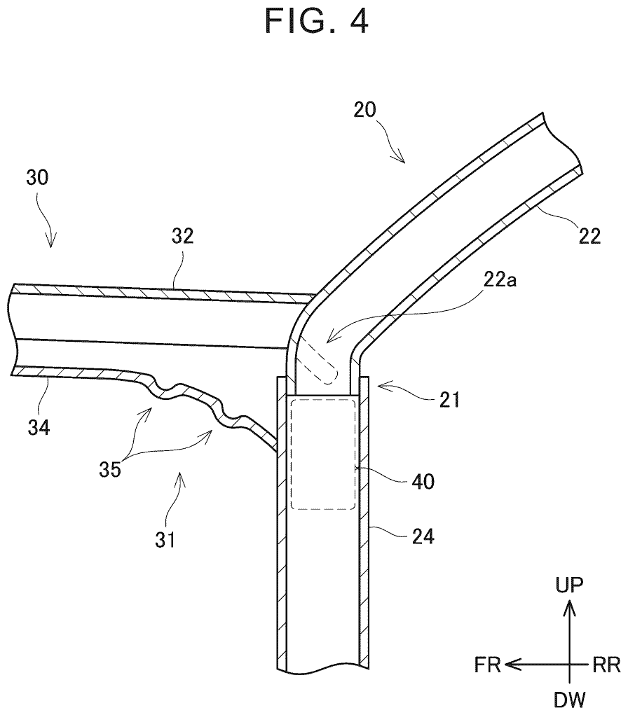

In the body 10 of the present embodiment, the material of the fourth panel 24 of the front pillar 20 has a lower tensile strength than the material of the third panel 22 of the front pillar 20. That is, the fourth panel 24 constituting the lower part of the front pillar 20 is made of a material with a relatively low tensile strength. Therefore, when the deformed upper member 30 interferes with the front pillar 20, the fourth panel 24 undergoes plastic deformation. The deformed upper member 30 is housed in an internal space 40 (see FIG. 4) of the front pillar 20, and displacement of the front pillar 20 toward the cabin 12 is suppressed.

As shown in FIG. 3, a lower end portion 22a of the third panel 22 of the front pillar 20 has a shape having a lower yield strength than the other portion of the third panel 22 that is adjacent to the lower end portion 22a. Specifically, the lower end portion 22a of the third panel 22 is provided with a cutout portion 22b in which part of the member of the third panel 22 is cut out. With this configuration, as shown in FIG. 4, when the deformed upper member 30 interferes with the front pillar 20, the lower end portion 22a of the third panel 22 can also undergo plastic deformation. Therefore, the deformed upper member 30 is smoothly housed in the internal space 40 of the front pillar 20, and the displacement of the front pillar 20 toward the cabin 12 can further be suppressed.

Although the embodiments have been described in detail above, the embodiments are merely examples and do not limit the scope of claims. The technologies described in the claims include various modifications and alternations of the specific examples illustrated above. The technical elements described in the present specification or illustrated in the drawings exhibit technical utility alone or in various combinations, and are not limited to the combinations described in the claims as filed. The technologies described in the present specification or illustrated in the drawings may simultaneously achieve a plurality of objects, and exhibit technical utility by achieving one of the objects.

What is claimed is:

1. A body of a vehicle, the body comprising:
a front pillar extending in an up-down direction in front of a cabin; and
an upper member extending forward from a middle position of the front pillar, wherein
a rear end portion of the upper member that is connected to the front pillar includes a first panel that constitutes an upper part of the upper member, and a second panel that faces the first panel and constitutes a lower part of the upper member,
a material of the first panel has a higher tensile strength than a material of the second panel, and
the second panel is expanded downward such that a sectional shape of the upper member expands toward the front pillar.

2. The body according to claim 1, wherein the second panel has an uneven shape that induces plastic deformation of the second panel in response to a load from a front.

3. The body according to claim 1, wherein:
the front pillar includes a third panel extending upward from the middle position of the front pillar, and a fourth panel extending downward from the middle position of the front pillar; and
a material of the third panel has a higher tensile strength than the material of the first panel.

4. The body according to claim 3, wherein a material of the fourth panel has a lower tensile strength than the material of the third panel.

5. The body according to claim 3, wherein a lower end portion of the third panel of the front pillar has a shape having a lower yield strength than another portion of the third panel that is adjacent to the lower end portion.
